(19) United States
(12) Patent Application Publication
(10) Pub. No.: US 2007/0290844 A1
(43) Pub. Date: Dec. 20, 2007

(54) Transportation security scanner

(76) Inventors: Sherline E. Colbert, Fontana, CA (US); Gerald Colbert, Fontana, CA (US)

Correspondence Address: Galasso & Associates, LP, P.O. Box 26503, Austin, TX, 78755-0503, US

(21) Appl. No.: 11/453,615

(22) Filed: Jun. 15, 2006

(51) Int. Cl. G08B 13/18; B60Q 1/00; G08B 21/00

(52) U.S. Cl. 340/552; 340/438; 340/540

(57) ABSTRACT

A security system designed to be mounted adjacent a passenger entrance area of a bus or train. The security device scanning system includes a controller disposed within the bus or train, the two scanners configured in substantially a vertical manner proximate the passenger entrance area. The scanners further include a plurality of transmitters and receivers that detect materials using a plurality of detection methods including but not limited to x-ray, pulse induction and chemical sniffing. The security scanning system further includes a distress signaling system.

### FIELD OF THE INVENTION

The present invention relates a security scanner, more specifically but not by way of limitation, a security scanner that is designed to be mounted at the passenger entrance of train or bus that has the ability to screen boarding passengers for weapons or explosives.

### BACKGROUND

With the recent changes precipitated by certain events in the world, personal security is a top priority for many individuals. Increased security is now part of our everyday routine. Air travel now requires its passengers to be screened at a higher level than in recent years. Attendees to sporting events are usually screened by security agents before entering the stadium. Even theme parks and other local attractions regularly conduct security screening of the individuals entering the parks and the contents of any purses or backpacks that are carried by the individual.

The public transportation system utilized in many countries around the world is extremely extensive. From air travel to ground transportation, millions of individuals use on a daily basis some form of public transportation. In many areas, daily commuters regularly use a municipal train or bus systems.

One issue with the current municipal train or bus systems is that there is no regular screening of passengers that are boarding the trains or busses. As millions of people travel everyday, this lack of security screening presents a significant threat to the safety of the people on the busses and trains as well as any group of people or building that are adjacent to the planned route of the bus or train.

Accordingly, there is a need for an automated security screening system that has the ability to detect items such as but not limited to weapons, chemicals and improvised explosive devices that are being carried by individuals boarding a bus or train.

### SUMMARY OF THE INVENTION

It is the object of the present invention to provide a security scanner that has the ability to detect a plurality of potential weapons such as but not limited to guns, knives or explosive chemicals.

It is a further object of the present invention to provide a scanner that utilizes a dual energy x-ray system that can provide a visual image of each boarding passenger to the driver of the bus or train.

It is another object of the present invention to provide a security scanner that further utilizes a chemical sniffer to detect trace amounts of organic materials that are known to be used in manufacturing explosive devices.

It is a further object of the present invention to provide a security scanner that further utilizes a pulse induction metal detector to detect metal objects of boarding passengers.

It is another object of the present invention to provide a security scanner that enhances the security of the passengers of municipal transportation systems such as busses or trains.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention; and

FIG. 2 is a perspective view of an embodiment of the present invention as mounted in the entrance of a passenger bus.

### DETAILED DESCRIPTION

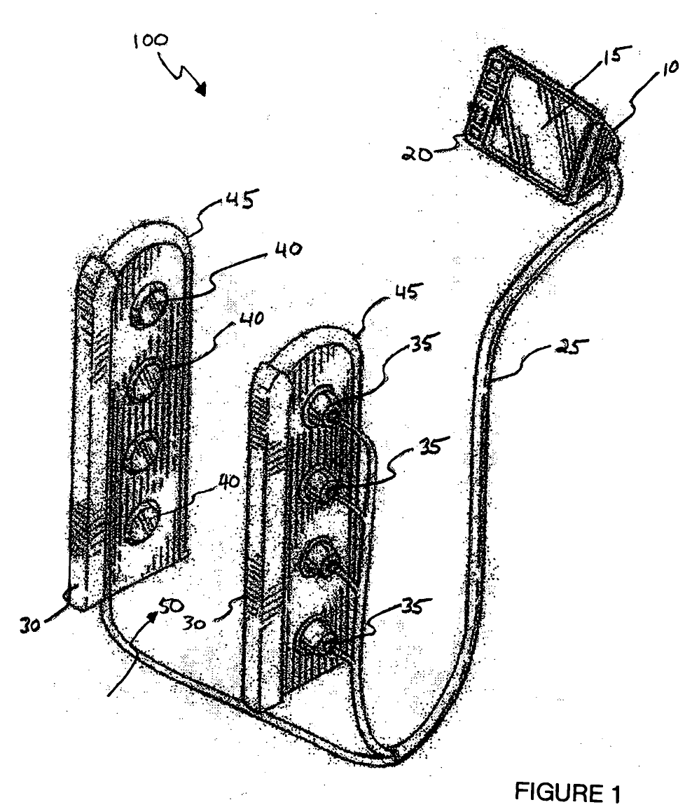

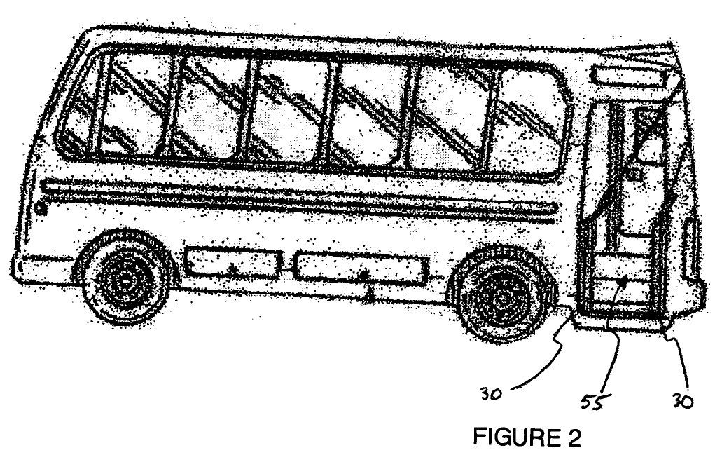

Referring now to the drawings submitted herewith, in particular FIGS. 1 and 2, wherein various elements depicted therein are not necessarily drawn to scale and wherein like elements are identified with like reference numerals, there is illustrated a security scanner 100 constructed according to the principles of the present invention.

The security scanner 100 comprises a controller 10 which is connected to two scanners 30 via power and communication cable 25. The controller 10 has integrally mounted thereon a screen 15 and a plurality of control buttons. The controller 10 provides power and operation for a plurality of transmitters 40 and receivers 35 that are connected thereto via a cable 25. The security scanner 100 is powered from a source such as but not limited to an on-board generator or the battery of the vehicle.

Scanners 30 include housings 45 are provided to house transmitters 40 and receivers 35, which are mounted therein. The transmitters 40 and receivers 35 are configured in a substantially vertical manner on the housing 45 of the scanners 30. Although no specific number of transmitters 40 and receivers 35 are required, good results have been achieved with four transmitters 40 and four receivers 35. Those skilled in the art should recognize that the transmitters 40 and the receivers 35 could be arranged in numerous different patterns and still achieve the desired functionality as described herein.

Scanners 30 are generally mounted proximate the area of a passenger entrance of a bus or train. Scanners 30 communicate with the controller via the cable 25. Those skilled in the art will recognize that any number of scanners 30 could be utilized to detect desired objects for the security scanner 100 to function as described herein. More specifically but not by way of limitation, one scanner 30 could be mounted adjacent to each passenger entrance area 55 of a bus or train (see FIG. 2).

The transmitters 40 and receivers 35 mounted on the scanners 30 are operable to function in multiple modes of detection. In one detection mode, the transmitters 40 and receivers 35 utilize a conventional x-ray scanning system to scan images of the boarding passengers and project the image on the screen 15. As is known to those skilled in the art, X-rays are similar to light waves in that they are electromagnetic waves, but x-rays are more energetic, allowing them to penetrate many materials. The security scanner 100 utilizes a conventional dual-energy X-ray system. This system utilizes at least one of the transmitters 40 to project X-rays, typically in the range of 140 to 160 kilovolt peak. Those skilled in the art should recognize that the transmitters 40 could project x-rays with a various amount of kilovolt peaks to achieve the desired functionality as described herein.

Subsequent to the X-rays pass through the boarding passenger and any objects being carried by the passenger, the X-rays are picked up by one of a plurality of receivers 35. The receivers 35 then passes the data collected from the X-rays to controller 10 via the cable 25. The controller 10 analyses the data received and displays corresponding information on screen 15.

As different materials absorb X-rays at different levels, the image on the screen 15 lets the driver of the bus or train see distinct items being carried by the passenger. It is further contemplated within the scope of the present invention that the items are typically colored on the screen 15, based on the range of energy that passes through the object, to represent one of three main categories: organic, inorganic and metal. While those skilled in the art will recognize that numerous different colors can be used to signify inorganics or metal objects, it is contemplated within the scope of the present invention that the security scanner 100 use a shade of orange displayed on the screen 15 to signify organic material as organic material is commonly used to manufacture explosive devices.

In a second detection mode, at least one of the transmitters 40 and receivers 35 function as a conventional metal detector to further screen passengers as they board the bus or train through the passenger entrance area 55. It is contemplated that one such metal detector operation is a conventional metal detection system based on pulse induction. Conventional pulse induction systems use a coil of wire in the transmitter 40 and receiver 35. The controller 10 controls short bursts of current through the coil of wire. Each pulse generates a brief magnetic field between the scanners 30. When the pulse ends, the magnetic field reverses polarity and collapses very suddenly, resulting in a sharp electrical spike that is detected in the controller 10. The electrical spike lasts a few microseconds and subsequently another current to be transmitted through the transmitter 40 and receiver 35 is generated. This subsequent current is called the reflected pulse and lasts approximately 30 microseconds. The controller 10 repeats this process as passengers board the bus or train traversing through the passenger entrance area 55 with the scanners 30 being disposed on opposite sides thereof. The security scanner 100 generates approximately 100 pulses per second. Those skilled in the art will recognize that the security scanner 100 could generate a wide variety of pulses per second. More specifically but not by way of limitation the security scanner 100 could generate pulses per second from a range of approximately twenty-five pulses per second to one thousand pulses per second.

When a passenger carrying a metal object passes through the scanner area 50, the pulse creates an opposite magnetic field in the object. When the pulse's magnetic field collapses, causing the reflected pulse, the magnetic field of the object results in a longer time for the reflected pulse to dissipate. A sampling circuit is present in the controller 10 that monitors the length of the reflected pulse. The controller 10 compares the pulses length to its expected length, thus determining if another magnetic field has caused the reflected pulse to take longer to decay. If the decay of the reflected pulse takes more than a few microseconds longer than normal, the controller 10 uses an alarm system disposed therein to notify the driver of the bus or train that the boarding passenger traversing through the passenger entrance area 55 is in possession of a metal object that could potentially be a weapon. It is further contemplated within the scope of the present invention that the security scanner 100 utilizes a multi-zone metal detection system whereby the security scanner 100 has disposed thereon a plurality of transmitters 40 and receivers 35 at different heights configured in a substantially vertical manner integrally mounted to the housing 45 as is illustrated in particular in FIG. 1.

A third mode of detection performed by the transmitters 40 and receivers 35 is a detection system commonly referred to as chemical sniffing. Typically in this mode, the security scanner 100 will operate at random intervals, or can be activated by the driver using the controller buttons 20 adjacent to the screen 15. At least one of the transmitter 40 produces a blast of air as a passenger traverses through the passenger entrance area 55 and at least one of the receivers 35 on opposing sides analyze the air for any trace residue of the types of chemicals used to make improvised explosive devices. If there is any residue, the receiver 35 transmits a signal to the controller 10 via the cable 25 warning the driver of a potential chemical weapon.

Still referring in particular to FIG. 1, it is contemplated that the controller 10 illustrated in its perspective view, has disposed therein a distress signal system such as but not limited to an emergency position indicating radio beacon (EPIRB). A conventional EPIRB is a sophisticated device that contains: a 5-watt radio transmitter that typically operates at 406 MHz, a 0.25-watt radio transmitter operating at 121.5 MHz and a global positioning system receiver. Upon activation, both of the radios start transmitting to a satellite. Embedded in the signal is a unique serial number, and, since the controller 10 is equipped with a global positioning receiver, the controller 10 will transmit the exact location of the bus or train to the proper authorities if a potential weapon is detected on a person traversing through the scanner area 50. Those skilled in the art will recognize that numerous different radio frequencies could be utilized to transmit a distress signal upon detection of a potential weapon by the security scanner 100 on a boarding passenger.

It is further contemplated to be within the scope of the invention that the controller 10 and scanners 30 could communicate via a wireless connection with each having a separate power connection. Additionally it is contemplated that controller 10 could be in wireless communication with a central monitoring station to provide additional monitoring capabilities, if for example the driver became preoccupied.

Additionally, it is contemplated that both hidden and non-hidden cameras could be incorporated into security scanner 100 to transmit to a second location visual images of the activities occurring on the vehicle, especially upon the detection by scanners 30 of an undesirable material brought onto the vehicle.

Referring to the drawings submitted herewith, in particular FIGS. 1 and 2, a description of the operation of the security scanner 100 is as follows. In use, the security scanner 100 is utilized on multi-passenger vehicles such as but not limited to busses or trains. The controller 10 is substantially disposed within the vehicle generally adjacent to the driver area. The scanners 30 are connected thereto via the cable 25. The scanners 30 are typically mounted adjacent to the passenger entrance area 55 with each scanner 30 being mounted on opposing sides of the passenger entrance area 55. Once activated by the driver, the security scanner 100 utilizes either independently or simultaneously multiple modes of detection such as pulse induction metal detection, x-ray detection and chemical detection. Upon activation, the receiver 35 transmits a data signal to the controller 10, which displays corresponding data on the screen 15, notifying the driver of the detection. Upon the detection of a threat, controller 10 will then notify the proper authorities utilizing a distress signal system such as but not limited to an emergency positioning indicating radio beacon. The security scanner 100 is operated in this manner as the vehicle to which it is mounted travels its intended route.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A security detection system for a vehicle, comprising:
at least one scanner configured to be mounted proximate an opening of a vehicle, said at least one scanner operable to scan for and detect predetermined materials being transported onto a vehicle; and
a controller in communication with said at least one scanner, said controller at least for communication to a user information corresponding to said at least one scanner scanning materials.

2. The security detection system as recited in claim 1, and further including a display for displaying information corresponding to said at least one scanner scanning materials.

3. The security detection system as recited in claim 2, wherein said at least one scanner includes a plurality of transmitters and receivers, said plurality of transmitters and receivers being operable in a plurality of detection modes.

4. The security detection system as recited in claim 3, wherein said plurality of transmitters and receivers perform detection of materials using at least one of an x-ray detection mode, a metal detection mode and chemical detection mode.

5. The security detection system as recited in claim 4, wherein said metal detection mode is a pulse induction detection mode utilizing a range of pulses from twenty five pulses per second to one-thousand pulses per second.

6. The security detection system as recited in claim 1, wherein said controller further for communicating a distress signal.

7. A material detection device designed for a passenger vehicle, comprising:
a controller, said controller being disposed in the interior of the passenger vehicle, said controller further including a display screen and a plurality of controller buttons;
at least two scanners, said scanners configured to detect desired materials being carried on a person entering the vehicle, said at least two scanners being mounted proximate an entrance to the passenger vehicle;
a first of said at least two scanners including a plurality of transmitters, said plurality of transmitters configured in a substantially vertical manner; and
a second of said at least two scanners including a plurality of receivers, said plurality of receivers configured in substantially vertical manner.

8. The material detection device as recited in claim 7, wherein said controller including a distress signaling system, said distress signaling system configured to generate a distress signal upon detection of a desired material by said at least two scanners.

9. The material detection device as recited in claim 8, wherein said distress signaling system is an emergency position indicating radio beacon configured.

10. The material detection device as recited in claim 9, wherein said at least two scanners are operable in at least one of a metal detection mode, x-ray detection mode and chemical detection mode.

11. The material detection device as recited in claim 10, wherein said x-ray detection mode operates in the range of 140 to 160 kilovolt peak.

12. The material detection device as recited in claim 11, wherein said x-ray detection system mode is configured to detect at least one of organic material, inorganic material, and metallic material.

13. The material detection device as recited in claim 10, wherein said metal detection mode is a pulse induction system configured to operate at a range of 25 to 1,000 pulses per second.

14. The material detection device as recited in claim 12, wherein said display device is operable to display data corresponding to detected organic material, wherein at least some of said data corresponding to detected organic material is displayed in the color orange on said display.

15. A security detection system for land base vehicles, such as busses and trains, the security system being designed to detect materials commonly for weapons disposed on passengers boarding the vehicles, comprising:
a controller, said controller being disposed in the interior the vehicle, said controller being positioned proximate to the operator of the vehicle, said controller further including a display screen and a plurality of controller buttons;
a first and a second scanners, said first and second scanners configured to detect desired materials being carried on a person adjacent thereto, said scanners being mounted proximate the entrance to the vehicle, said scanners being configured in a substantially vertical manner;
said first scanner including four transmitters, said four transmitters configured in a substantially vertical manner; and
said second scanner including four receivers, said four receivers configured in substantially vertical manner.

16. The security detection system as recited in claim 15, wherein said controller and said first and second scanners being connected via a cable, said cable operable to communicate signals between said first and second scanners and said controller.

17. The security detection system as recited in claim 16, and further including a distress signaling system, said distress signaling system being disposed within said controller, said distress signaling system configured to generate a distress signal upon detection of a desired material by said material detection device.

18. The security detection system as recited in claim 17, wherein said transmitters and said receivers operate to perform detection of materials in at least one of a metal detection mode, an x-ray detection mode and chemical detection mode.

19. The security detection system as recited in claim 18, wherein said x-ray detection mode is configured to detect material of at least one of organic material, inorganic material, and metallic material.

20. The security detection system as recited in claim 19, wherein said x-ray detection mode operates in the range of 140 to 160 kilovolt peak.
